(19) United States
(12) Patent Application Publication
(10) Pub. No.: US 2025/0371105 A1
(43) Pub. Date: Dec. 4, 2025

(54) FAST AND RESOURCE-EFFICIENT APPROXIMATION FOR THE EXPONENTIAL FUNCTION

(71) Applicant: Robert Bosch GmbH, Stuttgart (DE)

(72) Inventors: Cecilia Eugenia De La Parra Aparicio, Herrenberg (DE); Shubham Rai, Weil Der Stadt (DE)

(21) Appl. No.: 19/211,649

(22) Filed: May 19, 2025

(30) Foreign Application Priority Data
May 29, 2024 (EP) 24 17 8765.4

(51) Int. Cl. G06F 17/17

(52) U.S. Cl. CPC G06F 17/17; G06F 2101/10

(57) ABSTRACT

A method for computing an approximate value A of the exponential function e^{x} of an argument x. The method includes: approximating e^{x} with a Taylor expansion T around x=0 that includes a predetermined number n of terms with i-th powers xⁱ of the argument x divided by the respective factorial of i, with i=1, . . . , n, and in the computation of each term, approximating the factorial of i to the nearest power of 2, p(i!).

### CROSS REFERENCE

The present application claims the benefit under 35 U.S.C. § 119 of European Patent Application No. 24 17 8765.4 filed on May 29, 2024, which is expressly incorporated herein by reference in its entirety.

### FIELD

The present invention relates to the computation of the exponential function in a manner that can be performed more efficiently on a computing platform, thereby saving processing time and allowing to downsize the computing platform.

### BACKGROUND INFORMATION

When evaluating the output of a neuron in a neural network, inputs to this particular neuron are aggregated in a weighted sum, and the result is processed to the final output by means of a nonlinear activation function. A very common activation function is the softmax function. In particular, this activation function is placed in layers where normalized probabilities are required.

Calling the softmax function very frequently comes at the price that this function is computationally expensive. The main reason for the computational complexity is the computation of the exponential function e^{x}. This requires significant floating-point operations or large lookup tables.

It is conventional to approximate e^{x} by a Taylor series around x=0 of the form

$${e}^{x} \approx 1 + \frac{x}{1 !} + \frac{{x}^{2}}{2 !} + \frac{{x}^{3}}{3 !} + … + \frac{{x}^{n}}{n !} .$$

However, this still involves computation of a power of x, computation of a factorial, and a division.

### SUMMARY

The present invention provides a method for computing an approximate value A of the exponential function e^{x} of an argument x. This method builds upon the conventional approximation of e^{x} with a Taylor expansion T around x=0 that comprises a predetermined number n of terms with i-th powers x of the argument x divided by the respective factorial of i, with i=1, . . . , n, such that

$${e}^{x} \approx 1 + {\sum }_{i = 1}^{n} \frac{{x}^{i}}{i !} .$$

In the computation of each term, the factorial of i is approximated by the nearest power of 2, p(i!). That is, 2!=2 is already a power of 2, 3!=6 is approximated as either 4 or 8, 4!=24 is approximated as either 16 or 32, and 5!=120 is approximated as 128.

It was found that the “next power of 2” approximation brings about a surprisingly large savings in complexity because it saves the expensive hardware implementation of division. Rather, a multiplication or division by a power of 2 may be implemented by a simple bit-shift operation that is one of the most basic computing operations on many hardware architectures and therefore very fast and with small hardware blocks in the hardware architecture. That is, the hardware platform need not even be equipped with larger circuitry that is capable of computing the division. This circuitry can be saved, which means that the complete circuitry that is necessary to compute the output O of the neural network fits into a smaller area on the chip. At the same time, this reduces power consumption, and in particular leakage energy. Of course, the approximation to the nearest power of 2 will cause some error. But it has been found that, surprisingly, this causes only a small error in the desired end result, namely the final output O of the neural network. That is, in a neural network where many exponentials are computed and many approximation errors are made, their effects on the final result at least partially cancel each other out.

In a further particularly advantageous embodiment of the present invention, the argument x is decomposed into a product of an integer X_{q} and a non-integer scaling factor Δₓ. This scaling factor Δₓ is expressed as a power of 2 with an exponent of Δₓ*, so that Δₓ=2^{Δ}^{^{*}}^{ₓ}. In this manner, the computation of the power xⁱ of x is reduced to a computation of an integer power X_{q}ⁱ of the integer X_{q} and multiplication with a power of 2. Again, this multiplication may then be implemented by a suitable bit-shift operation. Since the exponent Δₓ* is non-integer, some approximation error will be made by discretizing to a bit-shift that corresponds to multiplication of an integer power of 2. But this discretization is similar to the “nearest power of 2” approximation of the factorial in the denominator of each term. This means that the final output O of the neural network will tolerate these approximation errors similarly well. The only hard work that remains is the computation of X_{q}ⁱ. But the hardware implementation of computing integer powers of integers requires much smaller structures than the hardware implementation of computing powers of floating-point values.

In a further particularly advantageous embodiment of the present invention, the sought approximation of e^{x}=e^{Δ}^{ₓ}^{X}^{_{q}} is decomposed into a product of 2^{n·Δ}^{ₓ}^{^{*}} and a remaining part f. The expression 2^{n·Δ}^{ₓ}^{^{*}} appears at the end of the computation of the approximation of e^{x}. Depending on what is further done with the obtained result, there is the possibility that this expression also appears on the other side of a fraction where e^{x} is computed, and cancels out with this.

For example, the computed approximate value A of e^{x} may be used in the computation of the softmax function

$$S ( {y}_{k} ) = \frac{exp ( {y}_{k} )}{{\sum }_{l = 1}^{m} exp ( {y}_{l} )}$$

of an element yₖ of an input vector y with m elements. This softmax function normalizes the m components so that they are all between 0 and 1, and they all add up to 1. Here, if the computation of e^{x} is decomposed into 2^{n·Δ}^{ₓ}^{^{*}}·f as presented above, the term 2^{n·Δ}^{ₓ}^{^{*}} will appear both in the numerator and in the denominator of the expression for S(yₖ). In the denominator, this can be pulled out of the sum, so the two instances of 2^{n·Δ}^{ₓ}^{^{*}} in the numerator and in the denominator cancel each other out. This means that, in a further advantageous embodiment, their computation can be omitted altogether.

Consider an example with n=3. Here, the approximate value A is given by

$$A = 1 + \frac{{Δ}_{x} {X}_{q}}{p ( 1 ! )} + \frac{{( {Δ}_{x} {X}_{q} )}^{2}}{p ( 2 ! )} + \frac{{( {Δ}_{x} {X}_{q} )}^{3}}{p ( 3 ! )} .$$

Expressing Δₓ as a power of 2 and at the same time approximating the denominator to the nearest power or 2 yields

$$A = 1 + \frac{{2}^{{Δ}_{x}^{*}} {X}_{q}}{{2}^{0}} + \frac{{2}^{2 {Δ}_{x}^{*}} {X}_{q}^{2}}{{2}^{1}} + \frac{{2}^{3 {Δ}_{x}^{*}} {X}_{q}^{3}}{{2}^{3}} .$$

Here, the term 2^{n·Δ}^{ₓ}^{^{*}}=2^{3Δ}^{ₓ}^{^{*}} may be pulled to the front to yield

$$A = {2}^{3 {Δ}_{x}^{*}} \cdot ( \frac{1}{{2}^{3 {Δ}_{x}^{*}}} + \frac{{X}_{q}}{{2}^{2 {Δ}_{x}^{*}}} + \frac{{X}_{q}^{2}}{{2}^{2 {Δ}_{x}^{*} + 1}} + \frac{{X}_{q}^{3}}{{2}^{3}} ) .$$

That is,

$$A = {2}^{3 {Δ}_{x}^{*}} \cdot f , f ( {Δ}_{x} {X}_{q} ) = ( \frac{1}{{2}^{3 {Δ}_{x}^{*}}} + \frac{{X}_{q}}{{2}^{2 {Δ}_{x}^{*}}} + \frac{{X}_{q}^{2}}{{2}^{2 {Δ}_{x}^{*} + 1}} + \frac{{X}_{q}^{3}}{{2}^{3}} ) .$$

Plugging this into the expression for S(yₖ) yields

$$S ( {y}_{k} ) = \frac{{2}^{3 {Δ}_{x}^{*}} \cdot f ( {Δ}_{x} {X}_{q} )}{{\sum }_{l = 1}^{m} {2}^{3 {Δ}_{x}^{*}} \cdot {f ( {Δ}_{x} {X}_{q} )}_{l}} = \frac{{2}^{3 {Δ}_{x}^{*}} \cdot f ( {Δ}_{x} {X}_{q} )}{{2}^{3 {Δ}_{x}^{*}} \cdot {\sum }_{l = 1}^{m} {f ( {Δ}_{x} {X}_{q} )}_{l}} .$$

Herein, the two instances of 2^{3Δ}^{ₓ}^{^{*}} in the numerator and in the denominator cancel each other out, so their computation may be omitted altogether.

As discussed above, in a further advantageous embodiment of the present invention, at least one multiplication of one number with a power of 2 to an exponent, and/or division of said number by said power of 2, is computed by bit-shifting the number for a number of bits corresponding to the exponent. This saves the need for more complex circuitry that would otherwise be required for performing the multiplication or division.

As discussed above, a major use case for the approximation of e^{x} presented here is using the computed approximate value A of e^{x}, and/or the computed value S(yₖ) of the softmax function, in the computation of the output O of a neural network. In particular, when evaluating such an output O of a neural network, the approximation of e^{x} is needed very many times. Therefore, the savings in processing time that are introduced by the simplifications brought about by the approximation add up to a substantial amount. Moreover, the need for particular structures to perform more complex computing operations is eliminated. This means that the hardware platform may be downsized in terms of area on the chip that it needs. This is particularly advantageous for applications in embedded systems, such as autonomous driving systems for vehicles or robots, production machines, or quality inspection machines. In these systems, the embedded systems on which the neural network is run are frequently under strict size and power constraints.

In a further particularly advantageous embodiment of the present invention, the computed approximate value A of e^{x}, and/or the computed value S(yₖ) of the softmax function, is used to compute the output O of a classifier network for images or other records of measurement data, and/or the output O of a multi-head attention module of a transformer network. These network architectures have shown to be particularly resilient against the approximation errors introduced by the approximation proposed here. That is, the approximation errors are unlikely to influence the final output O of the neural network. In particular, in a classification network, the approximation errors are unlikely to switch the class for which the highest classification score is obtained to another class. At the same time, these architectures make particularly heavy use of the exponential function, so the overall savings in processing time are more pronounced.

In many applications of neural networks, not all inputs are equally difficult to process. In particular, in applications involving classification tasks, for some inputs, it is clear very quickly what the final decision will be, whereas, for other inputs, the final decision is not apparent until all layers have been processed. This means that, for differently difficult inputs, the resilience of the final output O against approximation errors introduced by the approximation of e^{x} may be different as well. For less difficult inputs, the power series may be shortened, i.e., a lesser number n of terms may be used. The saved time may then be used on more difficult inputs that may need a more exact approximation of e^{x} with a higher n. How difficult a particular input is may, for example, be determined from confidences C of outputs O of the neural network.

Therefore, in a further particularly advantageous embodiment of the present invention, a confidence C of the output O of the neural network is determined. In response to this confidence C meeting a predetermined condition, the number n of terms used in subsequent computations of the approximate value A of e^{x} is modified. In this manner, high numbers n of terms may be used only when really needed, and less processing capacity goes to “waste” on inputs for which the final result is clear very early into the processing already.

To this end, in particular, the number n of terms is controlled to be kept at the lowest value that is sufficient to achieve a predetermined minimum confidence C of the output O.

As discussed above, the lightweight approximation of e^{x} presented here allows to downsize the hardware platform that is used to compute the output O of the neural network. Therefore, in a further particularly advantageous embodiment, the neural network is implemented on a hardware platform with less memory, and/or less processing resources, than those which would be necessary to compute the output O without approximating the value of e^{x}. This applies both in the quantitative and in the qualitative dimension. Quantitative means that, of hardware resources of which at least one instance needs to be present no matter whether the approximation presented here is used or not, fewer instances need to be present if the approximation is used. Qualitative means that, of certain types of circuitry that would be needed if the approximation was not used, no instances need to be present in the hardware platform by virtue of the approximation being used. This qualitative type of downsizing does not make the hardware platform slower, but it renders the hardware platform incapable of doing certain things altogether, like multiplication or division.

In a further particularly advantageous embodiment of the present invention, the argument x is derived from measurement data acquired using at least one sensor. From the output O of the neural network, an actuation signal is computed. A vehicle, a driving assistance system, a robot, a quality inspection system, a surveillance system, and/or a medical imaging system, is actuated with the actuation signal. In this manner, the actuation signal can be determined faster, and the respective actuated technical system only requires a lesser-powered and/or lesser capable embedded system for processing the neural network.

The method of the present invention may be wholly or partially computer-implemented and embodied in software. The present invention therefore also relates to a computer program with machine-readable instructions that, when executed by one or more computers and/or compute instances, cause the one or more computers and/or compute instances to perform the method of the present invention described above. Herein, control units for vehicles or robots and other embedded systems that are able to execute machine-readable instructions are to be regarded as computers as well. Compute instances comprise virtual machines, containers or other execution environments that permit execution of machine-readable instructions in a cloud.

A non-transitory storage medium, and/or a download product, may comprise the computer program. A download product is an electronic product that may be sold online and transferred over a network for immediate fulfilment. One or more computers and/or compute instances may be equipped with said computer program, and/or with said non-transitory storage medium and/or download product.

In the following, the present invention will be described using Figures without any intention to limit the scope of the present invention.

### BRIEF DESCRIPTION OF THE DRAWINGS

FIG. 1 shows an exemplary embodiment of the method 100 for computing an approximate value A of the exponential function e^{x} of an argument x, according to the present invention.

FIG. 2 shows an illustration of the simplifications introduced by the approximation as per the method 100, according to an example embodiment of the present invention.

### DETAILED DESCRIPTION OF EXAMPLE EMBODIMENTS

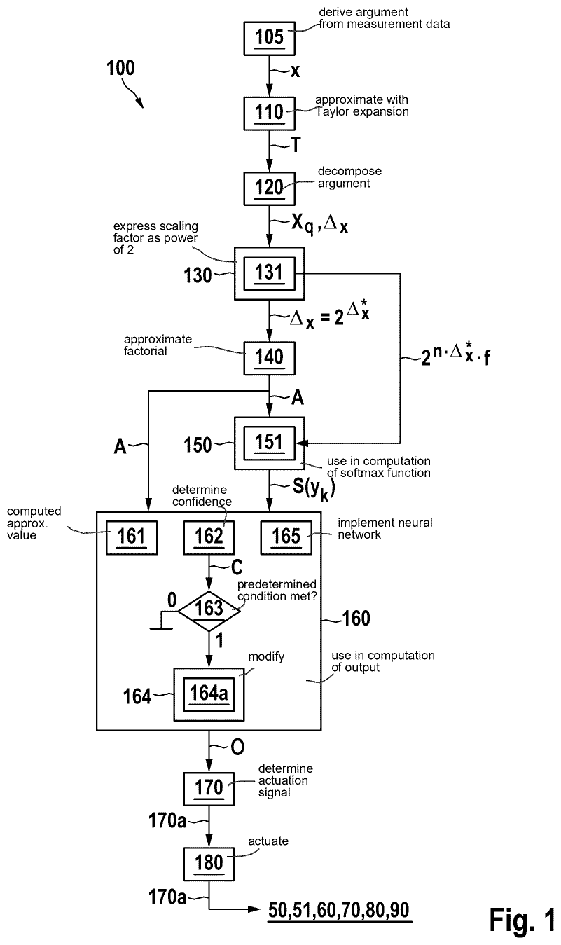

FIG. 1 is a schematic flow chart of an embodiment of the method 100 for computing an approximate value A of the exponential function e^{x} of an argument x.

According to block 105, the argument x may be derived from measurement data acquired using at least one sensor.

In step 110, e^{x} is approximated with a Taylor expansion T around x=0 that comprises a predetermined number n of terms with i-th powers xⁱ of the argument x divided by the respective factorial of i, with i=1, . . . , n.

In step 120, the argument x is decomposed into a product of an integer X_{q} and a non-integer scaling factor Δₓ.

In step 130, this scaling factor Δₓ is expressed as a power of 2 with an exponent of Δₓ*, so that Δₓ=24%.

According to block 131, the sought approximation of e^{x}=e^{Δ}^{ₓ}^{X}^{_{q}} may be decomposed into a product of 2^{n·Δ}^{ₓ}^{^{*}} and a remaining part f.

In step 140, in the computation of each term of the Taylor expansion T, the factorial of i is approximated to the nearest power of 2, p(i!). The computation of all terms of the Taylor expansion T yields the sought approximate value of e^{x}.

In step 150, the computed approximate value A of e^{x} is used in the computation of the softmax function

$$S ( {y}_{k} ) = exp ( {y}_{k} ) / {\sum }_{l = 1}^{m} exp ( {y}_{l} )$$

of an element yₖ of an input vector y with m elements.

According to block 151, if A has been decomposed into 2^{n·Δ}^{ₓ}^{^{*}}·f according to block 131, computations of two instances of 2^{n·Δ}^{ₓ}^{^{*}} that appear in the numerator and in the denominator of S(yₖ) may be omitted.

In step 160, the computed approximate value A of e^{x}, and/or the computed value S(yₖ) of the softmax function, is used in the computation of the output O of a neural network.

According to block 161, the computed approximate value A of e^{x}, and/or the computed value S(yₖ) of the softmax function, may be used to compute the output O of a classifier network for images or other records of measurement data, and/or the output O of a multi-head attention module of a transformer network.

According to block 162, a confidence C of the output O of the neural network may be determined. It may then be determined in block 163 whether this confidence C meets a predetermined condition, such as being above or below a predetermined threshold value. If this is the case (truth value 1), then, according to block 164, the number n of terms used in subsequent computations of the approximate value A of e^{x} may be modified. In particular, according to block 164a, the number n of terms may be controlled to be kept at the lowest value that is sufficient to achieve a predetermined minimum confidence C of the output O.

According to block 165, the neural network may be implemented on a hardware platform with less memory, and/or less processing resources, than those which would be necessary to compute the output O without approximating the value of e^{x}.

In step 170, an actuation signal 170a is determined from the output O of the neural network.

In step 180, a vehicle 50, a driving assistance system 51, a robot 60, a quality inspection system 70, a surveillance system 80, and/or a medical imaging system 90, is actuated with the actuation signal 170a.

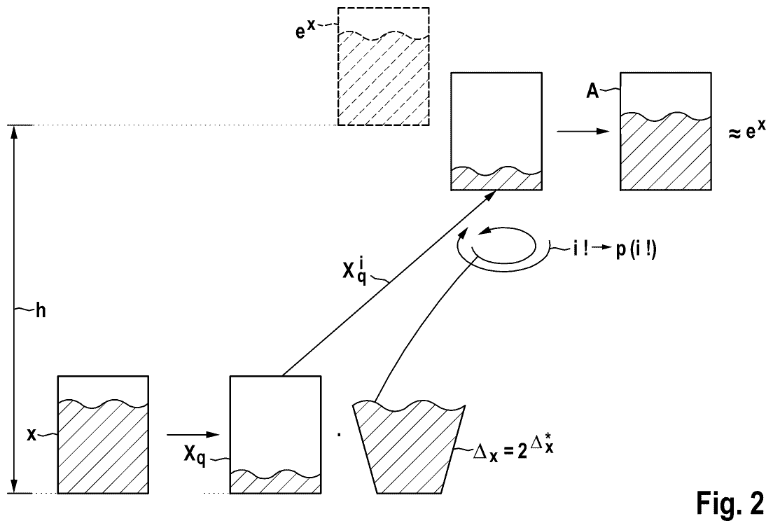

FIG. 2 illustrates the simplifications introduced by the approximation as per the method 100.

The task of computing e^{x} is sketched as lifting the argument x, drawn as a container filled with water, up a given height h. This is difficult because the water-filled container is heavy. The container can be lightened a lot by decomposing the argument x into an integer X_{q}, symbolized by a near-empty container, and a non-integer scaling factor Δₓ. Computing the i-th power X_{q}ⁱ of the integer X_{q} corresponds to lifting the near-empty container up the given height h.

There are two more computations required in the approximation. A power of the scaling factor Δₓ has to be computed, and a division by the factorial i! needs to be made. The scaling factor Δₓ is expressed as a power of 2 with an exponent of Δₓ*, so that Δₓ=2^{Δ}^{ₓ}^{^{*}}. This reduces the multiplication with the scaling factor 4, or a power thereof to a simple bit-shift operation, symbolized in FIG. 2 as an anti-clockwise rotation of the lifted near-empty container. The factorial i! is approximated to a nearest power of 2, p(i!). This reduces division by the factorial i! to a bit-shift operation in the other direction, symbolized by a clockwise rotation of the lifted near-empty container.

The end result is an approximation A that is close but not identical to the true value of e^{x}. This is symbolized by the container A not being at the full height h of e^{x} and having a lesser fill level than the container e^{x}.

What is claimed is:

1. A method for computing an approximate value A of the exponential function e^{x} of an argument x, comprising the following steps:
approximating e^{x} with a Taylor expansion around x=0 that includes a predetermined number n of terms with i-th powers xⁱ of the argument x divided by a respective factorial of i, with i=1, . . . , n; and
computing each of the terms by approximating the factorial of i to a nearest power of 2.

2. The method of claim 1, further comprising:
decomposing the argument x into a product of an integer X_{q} and a non-integer scaling factor Δₓ; and
expressing the scaling factor Δₓ as a power of 2 with an exponent of Δₓ*, so that Δₓ=2^{Δ}^{ₓ}^{^{*}}.

3. The method of claim 2, further comprising:
decomposing the approximation of e^{x}=e^{Δ}^{ₓ}^{X}^{_{q}} into a product of 2.4% and a remaining part f.

4. The method of claim 1, further comprising:
using the computed approximate value of e^{x} in the computation of a softmax function
$$S ( {y}_{k} ) = exp ( {y}_{k} ) / {\sum }_{l = 1}^{m} exp ( {y}_{l} )$$
of an element yₖ of an input vector y with m elements.

5. The method of claim 3, wherein computations of two instances of 2^{n·Δ}^{ₓ}^{^{*}} that appear in a numerator and in a denominator of S(yₖ) are omitted.

6. The method of claim 1, wherein at least one multiplication of one number with a power of 2 to an exponent, and/or division of the number by the power of 2, is computed by bit-shifting the number for a number of bits corresponding to the exponent.

7. The method of claim 1, further comprising:
using the computed approximate value of e^{x}, and/or the computed value S(yₖ) of the softmax function, in a computation of output O of a neural network.

8. The method of claim 7, wherein the computed approximate value of e^{x}, and/or the computed value S(yₖ) of the softmax function, is used to compute: (i) the output O of a classifier network for images or other records of measurement data, and/or (ii) the output O of a multi-head attention module of a transformer network.

9. The method of claim 7, further comprising:
determining a confidence C of the output O of the neural network; and
in response to the confidence C meeting a predetermined condition, modifying the number n of terms used in subsequent computations of the approximate value of e^{x}.

10. The method of claim 9, wherein the number n of terms is controlled to be kept at a lowest value that is sufficient to achieve a predetermined minimum confidence of the output O.

11. The method of claim 7, wherein the neural network is implemented on a hardware platform with less memory, and/or less processing resources, than those which would be necessary to compute the output O without approximating the value of e^{x}.

12. The method of claim 7, wherein the argument x is derived from measurement data acquired using at least one sensor, and wherein the method further comprises:
determining, from the output O of the neural network, an actuation signal; and
actuating, using the actuation signal, a vehicle and/or a driving assistance system and/or a robot and/or a quality inspection system and/or a surveillance system and/or a medical imaging system.

13. A non-transitory machine-readable storage medium on which is stored a computer program for computing an approximate value A of the exponential function e^{x} of an argument x, the computer program, when executed by one or more computers and/or compute instances, causing the one or more computers and/or compute instances to perform the following steps:
approximating e^{x} with a Taylor expansion around x=0 that includes a predetermined number n of terms with i-th powers xⁱ of the argument x divided by a respective factorial of i, with i=1, . . . , n; and
computing each of the terms by approximating the factorial of i to a nearest power of 2.

14. One or more computers and/or compute instances including a non-transitory machine-readable storage medium on which is stored a computer program for computing an approximate value A of the exponential function e^{x} of an argument x, the computer program, when executed by the one or more computers and/or compute instances, causing the one or more computers and/or compute instances to perform the following steps:
approximating e^{x} with a Taylor expansion around x=0 that includes a predetermined number n of terms with i-th powers xⁱ of the argument x divided by a respective factorial of i, with i=1, . . . , n; and
computing each of the terms by approximating the factorial of i to a nearest power of 2.
